(19) United States
(12) Patent Application Publication
(10) Pub. No.: US 2026/0112620 A1
(43) Pub. Date: Apr. 23, 2026

(54) Disordered Rocksalt Material and Method of Forming It

(71) Applicant: Wildcat Discovery Technologies, Inc., San Diego, CA (US)

(72) Inventors: Albert Voskanyan, San Diego, CA (US); Tanghong Yi, San Diego, CA (US); Bin Li, San Diego, CA (US)

(21) Appl. No.: 19/153,429

(22) PCT Filed: Mar. 14, 2024
(86) PCT No.: PCT/US2024/019840

§ 371 Date: Aug. 4, 2025

Related U.S. Application Data
(60) Provisional application No. 63/454,501, filed on Mar. 24, 2023.

(51) Int. Cl. H01M 4/525; H01M 4/02; H01M 4/1315; H01M 4/505; H01M 10/0525

(52) U.S. Cl. CPC H01M 4/525; H01M 4/1315; H01M 4/505; H01M 10/0525; H01M 2004/028

(57) ABSTRACT

A composition comprising a disordered rock salt having a cation comprised of lithium and at least one other metal and an anion comprised of oxygen having a coating comprised of a metal fluoride, a metal oxyfluoride or combination thereof may be made by a dry or wet method. The methods comprise intermixing a metal fluoride and a disordered rock salt and heating to a temperature to react a metal fluoride with the DRS. The method may form a spinel in addition to the metal fluoride or metal oxyfluoride, when in the presence of a base such as ammonium.

### FIELD

The present invention is in the field of battery technology.

### BACKGROUND

Lithium metal oxides have been used to formulate cathode materials for lithium ion batteries. The cathodes are derived from a few basic crystallographic structure types, such as spinels, olivines, and layered oxide structures. The layered oxide structures have included lithium-excess type structures, where additional lithium is present in the structure.

Recently, attention has been focused on disordered rocksalt structures, such as those formed from particular lithium metal oxides. Compounds represented by the formula:

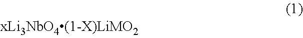

where M is a divalent or trivalent cation, have been shown to be a promising class of transition metal oxides for use as cathodes in lithium ion batteries. The compounds of formula (1) are considered a disordered rocksalt in which a random atomic arrangement of lithium and transition metal ions are packed in a closely-packed cubic structure. These disordered rocksalt compositions offer the ability to contain up to 3 lithium atoms per formula unit, which is more than the conventional lithium-excess layered materials. Formula (1) can be transformed and represented as LiₓM_{y}N_{z}O_{w}.

The disordered rocksalt structure is an attractive cathode material for next generation lithium ion batteries due to a greater specific energy density (e.g., a higher theoretical energy density) than state-of-the-art cathode materials, such as layered lithium metal oxide structures. For example, certain disordered rocksalt structure materials have a theoretical gravimetric energy density of about 1120 Wh/kg, while a LiMn₂O₄ active material has a theoretical gravimetric energy density of about 492 Wh/kg and a LiMn_{1.5}Ni_{0.5}O₄ has a theoretical gravimetric energy density of about 691 Wh/kg. This energy density is especially appealing when lower cost raw materials are used as components in the disordered rocksalt structure, such as manganese. As such, the disordered rocksalt materials can achieve relatively high energy density with relatively low material cost. In order to achieve comparable energy density, known cathode materials require higher-cost raw materials, such as cobalt or nickel.

Disordered rocksalt materials have tended to have a shorter cycle life compared to incumbent lithium ion batteries. Recently, attempts to improve the cycle life of disordered rock salt batteries has been described by substituting some of the oxygen with fluorine such as described in U.S. Pat. No. 10,280,092. Nevertheless, it would be desirable to provide a battery comprised of disordered rocksalt cathodes having longer life and other desirable attributes such as safer batteries.

### BRIEF SUMMARY

We discovered a coated disordered rocksalt (DRS). The coated DRS may exhibit longer long cycle life. The coated DRS is comprised of a metal fluoride, metal oxyfluoride or combination thereof. The coating is desirably the reaction product of a fluoride contacted with the DRS. The coating may be further comprised of a spinel that may arise from the reaction of the DRS with a metal fluoride.

Herein, when a majority is specified of a component, it means more than 50% by mole or (readily understood from the context used) to essentially all of that component (99% or less). That is, the majority specified constituent of a component is present in an amount greater than 50% to 99%, 90, 80%, 70% or 60% of that component. When a minority of a component is a specified constituent, it is present in an amount less than 50% to about 1% with the balance being the majority specified constituent.

An illustration is a composition comprising a disordered rock salt having a cation comprised of lithium and at least one other metal and an anion comprised of oxygen having a coating comprised of a metal fluoride, a metal oxyfluoride or combination thereof. The coated DRS desirably is the reaction product of a metal fluoride with the DRS.

A second illustration is method of forming the DRS, comprising, (i) intermixing, in the absence of a liquid, a disordered rock salt with a transition metal fluoride, alkaline earth fluoride or combination thereof to make a mixture and, (ii) heating the mixture to an annealing temperature of 400° C. to 600° C. to form the coated disordered rock salt.

The coated DRS may be used in primary and secondary batteries comprised of lithium. The coated DRS may be used with any suitable electrolyte, separator and anode such as those known in the art.

### BRIEF DESCRIPTION OF THE DRAWINGS

FIG. 1 shows the dQ/dV plots of batteries comprised of the coated DRS of this invention and batteries comprised of uncoated DRS.

FIG. 2 shows the X-ray diffraction patterns of manganese fluoride reacted with a DRS at differing temperatures.

FIG. 3 shows the DSC plot of manganese fluoride reacted with a DRS.

FIG. 4 is a schematic of two reaction pathways to forming the coated DRS.

FIG. 5 is an X-ray diffraction pattern and voltage trace of a coated DRS having a spinel phase.

### DETAILED DESCRIPTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range 1 to 3 includes the values 1 and 3 as well as the intermediate values.

The DRS compositions and morphology (e.g., structure) are useful in formulating electrodes of electrochemical cells. More specifically, the DRS may be used to form the cathode. The lithium ion battery includes an electrolyte formulation with a lithium salt present at a concentration suitable for conducting the lithium ions through the electrolyte formulation between the cathode and an anode during the discharge and recharge operations.

In a disordered rocksalt both lithium and a transition metal occupy a cubic close-packed lattice of octahedral sites. In electrochemical reactions, lithium diffusion proceeds by the lithium hopping from one octahedral site to another octahedral site via an intermediate tetrahedral site. Lithium in the intermediate tetrahedral site is the activated state in lithium diffusion. The activated tetrahedral lithium ion shares faces with four octahedral sites as follows: (i) the site previously occupied by the lithium ion itself; (ii) the vacancy the lithium ion will move into; and (iii & iv) two sites that can be occupied by lithium, a transition metal, or a vacancy.

The composition may be represented by

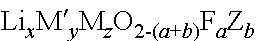

where 1.0<x<1.75; 0.01<y<0.55; 0.1<z<1; 0≤(a+b)<0.7; (b≥0) M′ is one of Ti, Ta, Zr, W, Nb, or Mo; M is one or more of Ti, V, Cr, Mn, Fe, Co, Ni, Cu, Zn, Al, Zr, Y, Mo, Ru, Rh and Sb; Z is one or more of P, N and S.

The amount of F and Z may be a majority or minority of the anion when Z is present (i.e., 0, F and one or more of P, S and N). Illustratively (a+b) may be 0.05 to 1.5, 1, 0.95, 0.8, 0.65, or 0.5). It may be desirable for a to be 0.05 to 0.25. Z may be any combination of P, N and S, or may be just one of them.

The composition may have any desirable Li of 1 or above, but it may be desirable for Li as represented by x to be at least 1.1, 1.15, or 1.2 to 1.65, 1.5 or 1.4.

The cation of the composition may be the metals described, but desirably, at least one of the metals as represented by M is comprised of one or more of Ti, Mn, Fe, Co, V, Cr, Ni and Cu. It may be desirable for M to be comprised of Ti and Mn. The composition may illustratively be one where M′ is comprised of Nb. When Nb is present, it may desirable for M to be comprised of one or more of Mn and Ti. Illustratively, M′ may be Nb and M may be Mn, Ti or Mn and Ti. When Nb and Mn are present with or without other metals, they may be present in a ratio of Mn/Nb of 1 or 2 to 5 or 10 by mole.

The DRS may be made by any suitable method such as those known in the art to make disordered rocksalts. Illustrative methods are described in U.S. Pat. Nos. 10,280,092, 10,978,706, copending U.S. application 63/348,797, and ACS Appl Mater Interfaces. 2019 Oct. 2; 11(39):35777-35787, each incorporated herein by reference.

Illustratively, the DRS desirably is comprised of micro-sized clusters or agglomerations of sub-micro-sized particles, which may be useful to increase the capacity and energy density of a battery cathode. The micro-sized clusters are also referred to herein as secondary particles. The secondary particles desirably have average particle sizes (e.g., diameters) in the micrometer scale, such as between 1 micrometer and 20 micrometers. The sub-micro-sized particles cluster to form the secondary particles. The sub-micro-sized particles are also referred to herein as primary particles. The terms “primary” and “secondary” indicate that the primary particles are formed before the secondary particles, and the secondary particles are agglomerations of the primary particles. The primary particles have average particle sizes (e.g., diameters) in the nanometer scale, such as less than 400 nanometers. The sub-micro primary particles of disordered rocksalt material may provide desirable conductivity and the micro-sized secondary particles of the disordered rocksalt material yield high electrode energy density.

The composition comprises a DRS having a cation of lithium and another metal and anion comprised of oxygen having a coating comprised of a metal fluoride, metal oxyfluoride or combination thereof. The coating is desirably the reaction product of the DRS and metal fluoride as described herein. The metal of the coating may be comprised of one or more of Cu, Mn, Mg, Ca and Co. It has been discovered that in the presence of a base such as ammonia, a spinel may be formed in addition to the metal oxyfluoride and metal fluoride. The metal of the coating (i.e., metal fluoride, metal oxyfluoride) may be a metal such as Cu, Mn, Mg, Ca and Co. The metal of the coating may be a metal in the DRS (i.e., reaction product of the DRS and a metal fluoride contacted with the DRS. The presence of the metal fluoride and metal oxyfluoride may be determined by a surface analysis method such as X-ray photo-spectroscopy (XPS).

Illustratively, the coated DRS may be formed by a wet or dry method. For example, the coated DRS may be formed by intermixing, in the absence of a liquid, a disordered rock salt with a transition metal fluoride, alkaline earth fluoride or combination thereof to make a mixture and heating the mixture to an annealing temperature of 400° C. to 600° C. to form the coated disordered rock salt. The coated DRS may be made by mixing a disordered rock salt with a transition metal ion and a fluoride ion dissolved in water to form a slurry at a coating temperature, removing the water to form a dried coated powder and, heating the dried coated powder to an annealing temperature of 400° C. to 600° C. to form the coated disordered rock salt.

The intermixing may be by any suitable method to realize the desired coating with examples being a milling method such as micromedia mill, ball mill, planetary mill or attrition mill. If desired, the metal fluoride and DRS may be separately milled and intermixed using conventional mixing of dry powders. The intermixing when employing a liquid (wet method) may use any suitable mixer such as those known in the art (e.g., colloid mill, axial and radial paddle mixers) and the aforementioned milling. An Example of a suitable micro bead mill is a Buhler PML2 mill (Buhler Group). The intermixing may be for any time useful to realize the desired coated DRS. The time, illustratively, may be from 5, 10, 30 minutes, 1 hour, 2 hours to 24, 12 or 6 hours.

The transition metal fluoride intermixed with the DRS may be a fluoride of a metal such as those described above. The fluoride may be a simple or complex fluoride (e.g., multiple metals and inclusive of an oxyfluoride). The fluoride may be an alkaline earth metal fluoride. The alkaline earth may be CaF₂ or MgF₂. The amount of transition metal fluoride or alkaline earth fluoride may be any useful amount to form the desired coating. Generally, the amount of the metal fluoride is about 1% or 2% to 10%, 8% or 5% by weight of the metal fluoride and DRS.

The temperature found to be useful to form the coated DRS having desired performance is from 400° C. to 600° C. It is understood that slightly less temperature of 10 or 20° C. may be useful with 500° C.±50° C. being generally suitable. The atmosphere may be any useful to form the coated DRS. Any suitable atmosphere may be used, with an inert atmosphere being useful such as a noble gas (e.g., argon).

When performing the wet method, the desired metal ion may be provided by dissolving a metal salt other than a metal fluoride in the water. The metal fluoride may be formed upon heating and further reactions may also occur involving the DRS. Illustratively, the fluoride may be provided by ammonium fluoride and the metal salt may be any suitable such as a nitrate, chloride, carboxylate and sulphate. Desirably, the metal ion is first dissolved in the water and then the fluoride ion (e.g., ammonium fluoride) is dissolved in the water. The DRS is mixed with the dissolved ions forming a slurry to a coating temperature below the boiling point of water to 20° C. Desirably, the coating temperature is from 40° C. to 90° C. for a time of 5 minutes to 2 hours.

The water may be removed by any suitable method such as those known in the art and may include combinations of water removal methods. The water may be removed by filtration, evaporation, sublimation or combination thereof. Illustratively, the water may be removed by filtration and heating above the boiling point of the water under a vacuum. In the wet process, a spinel phase may be formed, which is believed, without being limiting, to be due the presence of an ammonium species aiding the formation of the spinel. Metal fluorides of the same chemistry (e.g., MnF₂) in the dry process showed no evidence of the formation of a spinel phase by X-ray diffraction.

The DRS may be used to form a cathode by any suitable method such as those known in the art. For example, the DRS powder may be mixed with a binder such a polymer useful to make cathodes (e.g., polyfluoropolymer such as polyvinylidene fluoride) one or more solvents to form a slurry. Non-limiting examples of the one or more solvents may be an aprotic polar solvent such as N-methyl-2-pyrrolidinone (NMP). The slurry may then be deposited on a metal current collector (e.g., stainless steel, copper, or any suitable conductive metal foil) and the solvent removed to form the cathode.

Desirably the DRS of the cathode has an average secondary particle size of 1 to 20 micrometers. Each of the secondary particles is an agglomeration of primary particles. The DRS primary particles desirably have an average particle size as described and may contain other particles that may be useful such as increasing the electrical conductivity (e.g., carbon or other inorganic high ionic conductive particles).

The DRS cathode may be used in a rechargeable lithium ion battery cell. The battery cell includes the cathode, an anode, separator and electrolyte. The battery or battery cell may be formed in any suitable atmosphere such as common in the art. For example, a high purity argon atmosphere may be used to limit any undesirable contamination from species present in atmospheric air.

### Illustrations

Illustration 1. A composition comprising a disordered rock salt having a cation comprised of lithium and at least one other metal and an anion comprised of oxygen having a coating comprised of a metal fluoride, a metal oxyfluoride or combination thereof.

Illustration 2. The composition of illustration 1 wherein the disordered rock salt is represented by chemical formula (i):

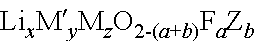

where 1.0<x<1.75; 0.01<y<0.55; 0.1<z<1; 0≤(a+b)<0.7; (b≥0) M′ is one of Ti, Ta, Zr, W, Nb, or Mo; M is one or more of Ti, V, Cr, Mn, Fe, Co, Ni, Cu, Zn, Al, Zr, Y, Mo, Ru, Rh and Sb; and Z is one or more of P, N and S.

Illustration 3. The composition of illustration 1 or 2, wherein the metal of the coating is comprised of a transition metal.

Illustration 4. The composition of any one of illustrations 1 or 2, wherein the metal of the coating is comprised of an alkaline earth metal.

Illustration 5. The composition of any one of the preceding illustrations, wherein the coating lacks a spinel.

Illustration 6. The composition of any one of illustrations 1 to 5, wherein the coating is comprised of a spinel.

Illustration 7. The composition of any one of the preceding illustrations, wherein the metal of the coating is comprised of one or more of Cu, Mn, Ca and Co.

Illustration 8. A method of forming a coated disordered rock salt comprising,
(i) intermixing, in the absence of a liquid, a disordered rock salt with a transition metal fluoride, alkaline earth fluoride or combination thereof to make a mixture and,
(ii) heating the mixture to an annealing temperature of 400° C. to 600° C. to form the coated disordered rock salt.

Illustration 9. The method of illustration 8, wherein the intermixing is by milling.

Illustration 10. The method of illustration 8 or 9, wherein the annealing temperature is for an annealing time of 15 minutes to 6 hours.

Illustration 11. A method of forming a coated disordered rock salt comprising,
(i) mixing a disordered rock salt with a transition metal ion and a fluoride ion dissolved in water to form a slurry at a coating temperature,
(ii) removing the water to form a dried coated powder and,
(iii) heating the dried coated powder to an annealing temperature of 400° C. to 600° C. to form the coated disordered rock salt.

Illustration 12. The method of illustration 11, wherein the metal ion is provided by dissolving a metal salt other than a metal fluoride in water.

Illustration 13. The method of illustration 12, wherein the fluoride ion is provided by dissolving ammonium fluoride.

Illustration 14. The method of illustration 13, wherein the disordered rock salt is first mixed with the transition metal ion and subsequently the ammonium fluoride is dissolved in the water to form the fluoride ion.

Illustration 15. The method of illustration 14, wherein the coating temperature is from 20° C. to below water's boiling point.

Illustration 16. The method of illustration 15, wherein the coating temperature is 40° C. to 90° C. for a coating time of 5 minutes to 2 hours.

Illustration 17. The method of any one of illustrations 11 to 16, wherein the annealing temperature is performed at an annealing time of 5 minutes to 6 hours.

Illustration 18. The method of any one of illustrations 11 to 17, wherein the coated disordered rock salt is comprised of a spinel.

Illustration 19. The method of illustration 18, wherein the spinel is comprised of Mn.

Illustration 20. A cathode comprising the composition of any one of illustrations 1 to 7.

Illustration 21. A battery comprising the cathode of illustration 20.

### Examples

Disordered rocksalt materials are synthesized via a conventional solid state reaction. Typically, stoichiometric amounts of precursors (Mn₂O₃, TiO₂, Nb₂O₅, Li₂CO₃ and LiF) are mixed in deionized water to make a suspension, which are ball milled with a planetary ball mill to decrease the particle size as well as to obtain a homogeneous mixture of all precursors. The mixture is dried at 100° C. for 12 h under air before being annealed between 700-900° C. for 1-24 hours under argon flow to obtain the disordered rocksalt phase.

CuF₂ coating was obtained using a dry coating process. The as-made DR material (1 g) was either pre-milled for 3 hours or used without milling and then milled (20 g for 3 h) with an amount (3, 5, or 8 wt %) of CuF₂ (Sigma Aldrich, 98%), followed by a post-annealing at 400° C., 500° C., or 600° C. for 5 hours under argon (20 ml min⁻¹) atmosphere to form the coated DR. The control material (“Comparative”, without milling with a fluoride) was also pre-milled and re-annealed at 400° C. for comparison.

MnF₂ coating is obtained using a dry coating process. The as-made DR material (1 g) was either pre-milled for 3 hours or used without milling and then milled (20 g for 3 h) with an amount (3 and 5 wt %) of MnF₂ (Sigma Aldrich, 97%), followed by a post-annealing at 400° C., 500° C., or 600° C. for 5 hours under argon (20 ml min⁻¹) atmosphere to form the fluoride coated DR. The control material was also pre-milled and re-annealed at 400° C. for comparison.

MnF₂ coating is made using a wet coating process. The as-made DR material (1.1 g) was pre-milled for 3 hours and then immersed in 10 ml aqueous solution containing Mn(NO₃)₂ (Sigma, >97%)) (0.05 or 0.085 g) and stirred at 500 rpm for 30 min. Then, NH₄F (Sigma, 99.99%) (0.01 or 0.017 g) is added to the solution and stirred for 3 h at 80° C. to produce MnF₂ coating (3 or 5 wt %) on DR. The resulting material is then dried at 80° C. overnight under vacuum. The dried material was annealed at either 400° C., 500° C., or 800° C. for 5 h.

MgF₂ coating was obtained using a dry coating process. The as-made DR material (1 g) was milled (20 g for 3 h) with an amount (1 or 3 wt %) of MgF₂ (Sigma Aldrich, 98%), followed by a post-annealing at 400, 500, 600 or 900° C. for 5 hours under argon (20 ml min⁻¹) atmosphere to form the coated DR. The control material was also pre-milled and re-annealed at 400° C. for comparison.

The fluoride coated DR powder is then milled with a carbon precursor (either acetylene black, carbon black, carbon fiber, graphite, carbon nanotube or KJ600) in a 96:4 (powder to carbon ratio) as active material to use for cathode casting. The resulting material is washed with deionized water and dried at 150° C. for 12 hours under vacuum.

Battery cells are assembled in a high purity argon filled glovebox (M-Braun, 02 and humidity content <0.1 ppm). The cathode is prepared by mixing the fluoride coated disordered rocksalt powder with poly(vinylidene fluoride) (Sigma Aldrich) and 1-methyl-2-pyrrolidinone (Sigma Aldrich), and the resulting slurry is deposited on a stainless steel current collector and dried to form a composite cathode film. For the anode, a thin Li foil is cut into the required size. Each battery cell included the composite cathode film, a polypropylene separator, and a lithium foil anode. An electrolyte (1.0 M LiPF6 in EC/EMC (1:2 v/v)) containing lithium hexafluororophosphate in a mixture of ethylene carbonate and ethyl methyl carbonate with an additive is used. The battery cell is sealed and cycled between 1.5-4.6V at 30° C. at C/20 formation rate and C/3 cycling rate, where 1 C=300 mAh/g. For full cell testing graphite anode has been used and battery has been cycled between 2-4.55V at 30° C. at C/20 formation rate and C/3 cycling rate.

TABLE 1

| | | | Cycle 1 | Cycle 1 |
|---|---|---|---|---|
| | CuF₂ | Annealing | Discharge | Coulombic |
| | Amount | Temperature | Capacity | Efficiency |
| Example | (wt. %) | (° C.) | (mAh/g) | (%) |
| Control | 0 | 400 | 316 ± 2.2 | 100 ± 4.8 |
| 1 | 3 | 400 | 319 ± 9.3 | 104 ± 2.2 |
| 2 | 3 | 500 | 316 ± 10.7 | 103 ± 2.2 |
| 3 | 3 | 600 | 292 ± 15.5 | 98 ± 1.9 |
| 4 | 5 | 400 | 309 ± 10.1 | 98 ± 6.4 |
| 6 | 5 | 500 | 301 ± 10.0 | 99 ± 1.9 |
| 7 | 5 | 600 | 286 ± 16.6 | 92 ± 1.2 |
| 8 | 8 | 500 | 286 ± 0.31 | 101 ± 0.4 |

DR cathodes with CuF₂ coatings demonstrated similar or improved cycle 1 coulombic efficiency (CE) and similar cycle 1 discharge capacity except for examples with high metal fluoride content and/or high annealing temperature as shown in Table 1. In some cases, the coated DR showed lower initial reversible capacity than the control, and the difference appears to be comparable to the weight of the electrochemically inactive coating materials.

TABLE 2

| | | | Cycle 100 | Cycle 100 | Cycle 100 |
|---|---|---|---|---|---|
| | CuF₂ | Annealing | Discharge | Capacity | Total |
| | Amount | Temperature | Capacity | Retention | Resistance |
| Example | (wt. %) | (° C.) | (mAh/g) | (%) | (Ohm) |
| Control | 0 | 400 | 144 ± 6.6 | 56 | 2613 |
| 1 | 3 | 400 | 140 ± 3.0 | 53 | 2534 |
| 2 | 3 | 500 | 136 ± 9.1 | 53 | 2600 |
| 3 | 3 | 600 | 158 ± 9.6 | 65 | 1482 |
| 4 | 5 | 400 | 147 ± 2.2 | 56 | 2352 |
| 5 | 5 | 500 | 156 ± 9.0 | 63 | 1771 |
| 7 | 5 | 600 | 153 ± 3.9 | 63 | 1261 |
| 8 | 8 | 500 | 165 ± 2.2 | 69 | 1160 |

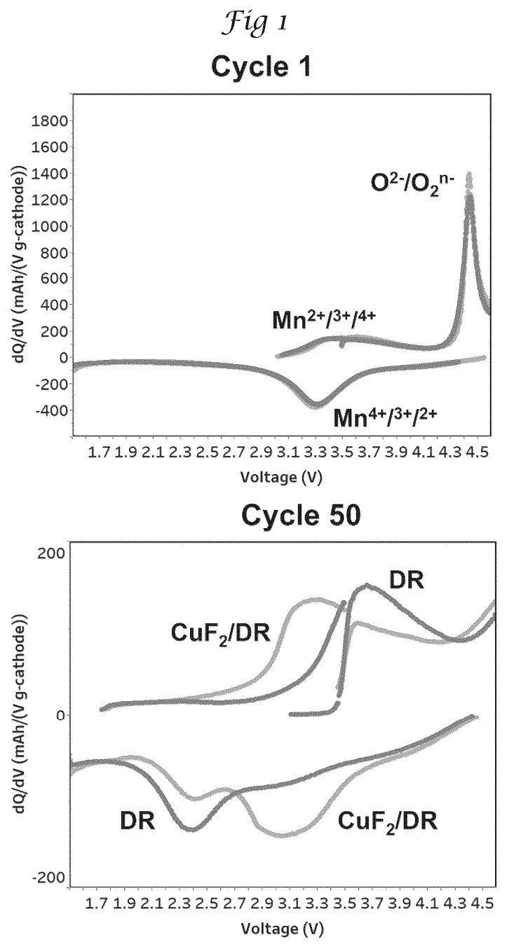

The cycle 1 graph of FIG. 1 of the derivative of the dQ/dV (differential capacity) shows peaks due to the oxidation and reduction of the DR cation (transition metal) and anion (oxygen). As shown, there are no significant changes in the redox contributions due to the cation and anion as the CuF₂ content increases. However, with increase in CuF₂ coating amount the cation redox peak at 3.3V doesn't shift much to lower potentials compared with uncoated DR after 50 cycles indicating enhancement in DR stability.

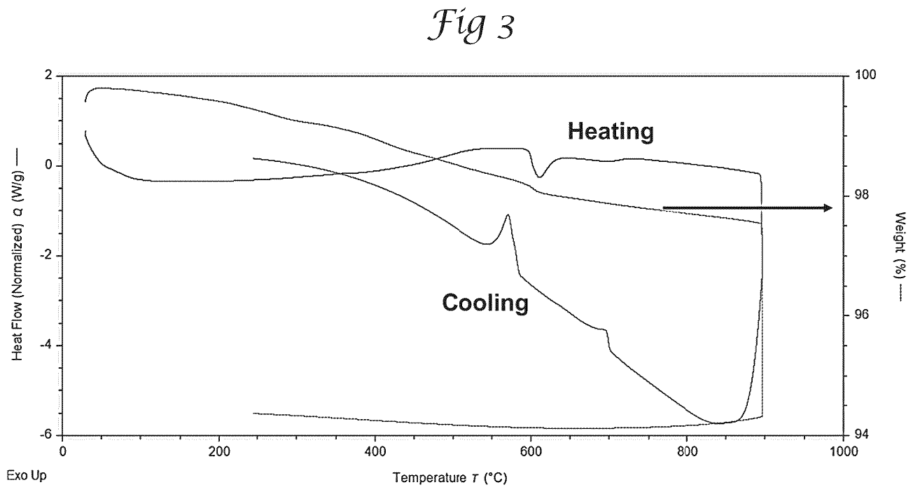

The cycle 100 capacity follows the same trend as the initial capacity, resulting in similar or improved capacity retention for coated materials relative to the control uncoated DR as shown in Table 2. Higher amounts of CuF₂ showed best improvement in capacity retention and lowest resistance growth during cycling. The annealing at 500° C. displays high initial capacity and improved cycling stability. Further increase in temperature results in decrease in initial capacity due to the possible reaction between DR and CuF₂, which may be exemplified by the peak exhibited in the DSC plot of FIG. 3.

For MnF₂ both wet and dry coating methods have been used. The results obtained for dry coating are similar to CuF₂. There is a decrease in capacity with increase in annealing temperature for MnF₂ coating. The optimum annealing temperature for MnF₂ coating is between 400-500′° C. Initial capacity and CE for varying amounts and annealing temperatures are shown in Tables 3 and 4.

TABLE 3

| | | | Cycle 1 | Cycle 1 |
|---|---|---|---|---|
| | MnF₂ | Annealing | Discharge | Coulombic |
| | Amount | Temperature | Capacity | Efficiency |
| Example | (wt. %) | (° C.) | (mAh/g) | (%) |
| Control | 0 | 400 | 318 ± 3.81 | 101 ± 1.33 |
| 1 | 3 | 400 | 316 ± 8.10 | 108 ± 1.30 |
| 2 | 3 | 500 | 313 ± 2.18 | 105 ± 1.38 |
| 3 | 3 | 600 | 292 ± 4.38 | 98 ± 1.05 |
| 4 | 5 | 400 | 312 ± 6.47 | 109 ± 0.5 |
| 5 | 5 | 500 | 302 ± 5.96 | 104 ± 1.86 |
| 6 | 5 | 600 | 302 ± 10.64 | 96 ± 2.10 |

TABLE 4

| | | | Cycle 100 | Cycle 100 | Cycle 100 |
|---|---|---|---|---|---|
| | MnF₂ | Annealing | Discharge | Capacity | Total |
| | Amount | Temperature | Capacity | Retention | Resistance |
| Example | (wt. %) | (° C.) | (mAh/g) | (%) | (Ohm) |
| Control | 0 | 400 | 151 ± 5.4 | 58 | 2229 |
| 1 | 3 | 400 | 162 ± 6.3 | 60 | 1948 |
| 2 | 3 | 500 | 173 ± 3.9 | 64 | 1813 |
| 3 | 3 | 600 | 158 ± 5.3 | 63 | 1283 |
| 4 | 5 | 400 | 170 ± 1.7 | 63 | 1623 |
| 5 | 5 | 500 | 168 ± 8.6 | 67 | 863 |
| 6 | 5 | 600 | 158 ± 10.3 | 70 | 811 |

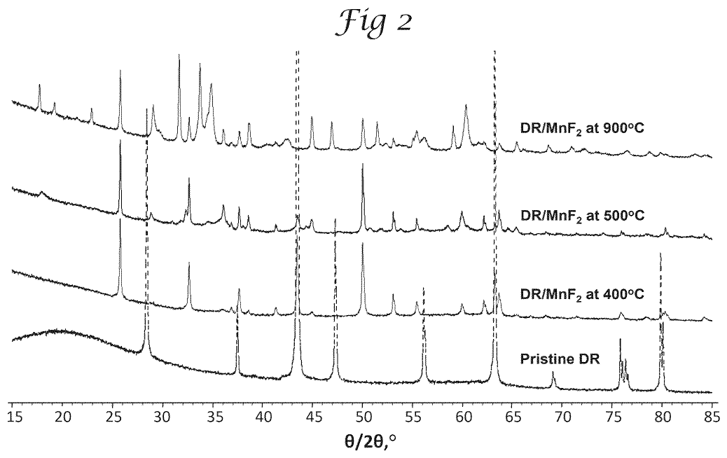

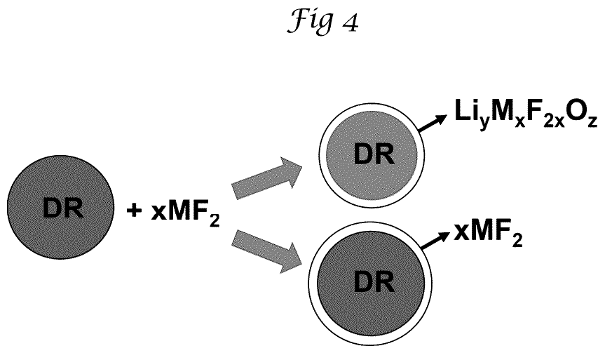

Dry coated DR cathode with MnF₂ showed significant improvement in capacity retention and resistance growth on cycling. The lithium in DR is chemically active and has high affinity towards fluoride anion. Therefore, upon heating, it is expected that there will be a chemical reaction between DR and metal fluoride forming a fluorinated compound on the DR surface. To verify show evidence of this, we ground pristine DR with MnF₂ in 1:1 molar ratio and performed TG/DSC as well as XRD analysis at different stages of heating (FIGS. 2 and 3). From XRD and DSC results it can be seen that there is an exothermic reaction between DR and metal fluoride starting at around 200° C. and an endothermic reaction around 600° C. It is believed up to about 600° C. desired complex fluorides or oxyfluorides as depicted in FIG. 4 are formed and a less desirable phase is formed above 600° C.

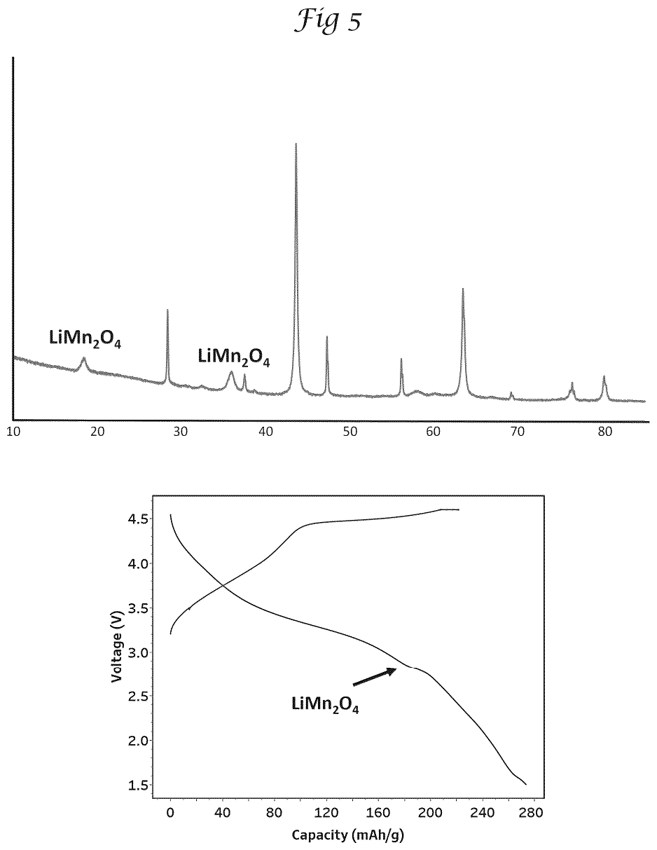

When the wet coating method is used to generate a MnF₂ coating, NH₄F precursor in aqueous solution may react with DR converting some of it into a Li₂MnO₃ spinel phase. The formation of spinel has been confirmed via XRD analysis and appearance of new characteristic plateau in voltage traces as shown in FIG. 5.

Initial capacity and CE for varying amounts and annealing temperatures Table 5. There is a decrease in capacity with increase in annealing temperature for MnF₂ wet coating. The optimum annealing temperature is found to be about 400° C. The cycling performance was also significantly improved with MnF₂ wet coating on the DR cathode material, as shown in Table 6.

TABLE 5

| | | | Cycle 1 | Cycle 1 |
|---|---|---|---|---|
| | MnF₂ | Annealing | Discharge | Coulombic |
| | Amount | Temperature | Capacity | Efficiency |
| Example | (wt. %) | (° C.) | (mAh/g) | (%) |
| Control | 0 | 400 | 315 ± 1.3 | 103 ± 1.3 |
| 1 | 3 | 400 | 294 ± 1.6 | 102 ± 3.6 |
| 2 | 3 | 500 | 288 ± 3.6 | 97 ± 1.7 |
| 3 | 5 | 400 | 286 ± 4.4 | 109 ± 0.4 |
| 4 | 5 | 500 | 272 ± 1.0 | 105 ± 0.5 |

TABLE 6

| | | | Cycle 100 | Cycle 100 | Cycle 100 |
|---|---|---|---|---|---|
| | MnF₂ | Annealing | Discharge | Capacity | Total |
| | Amount | Temperature | Capacity | Retention | Resistance |
| Example | (wt. %) | (° C.) | (mAh/g) | (%) | (Ohm) |
| CE1 | 0 | 400 | 178 ± 4.7 | 66 | 2308 |
| 1 | 3 | 400 | 189 ± 2.5 | 78 | 854 |
| 2 | 3 | 500 | 192 ± 0.6 | 79 | 718 |
| 3 | 5 | 400 | 201 ± 1.9 | 82 | 634 |
| 4 | 5 | 500 | 170 ± 0.6 | 73 | 738 |

The results obtained for dry coating of MgF₂ are shown in Tables 7 and 8. Initial capacity slightly decreases with MgF₂ coating; however, it should be noted that there is an increase in capacity from 400° C. to 500° C. calcination with following decrease afterwards. Based on initial capacity results 500° C. calcination appears to be the optimum condition.

TABLE 7

| | | | Cycle 1 | Cycle 1 |
|---|---|---|---|---|
| | MgF₂ | Annealing | Discharge | Coulombic |
| | Amount | Temperature | Capacity | Efficiency |
| Example | (wt. %) | (° C.) | (mAh/g) | (%) |
| Control | 0 | 400 | 312 ± 1.20 | 95 ± 0.85 |
| 1 | 1 | 500 | 268 ± 9.41 | 96 ± 0.1 |
| 2 | 3 | 400 | 290 ± 4.10 | 100 ± 0.25 |
| 3 | 3 | 500 | 304 ± 2.35 | 99 ± 0.2 |
| 4 | 3 | 600 | 285 ± 5.20 | 95 ± 1.5 |
| 5 | 3 | 900 | 220 ± 5.92 | 95 ± 0.38 |

TABLE 8

| | | | Cycle 100 | Cycle 100 | Cycle 100 |
|---|---|---|---|---|---|
| | | Annealing | Discharge | Capacity | Total |
| | Amount | Temperature | Capacity | Retention | Resistance |
| Example | (wt. %) | (° C.) | (mAh/g) | (%) | (Ohm) |
| Control | 0 | 400 | 151 ± 2.21 | 58 | 2374 |
| 1 | 1 | 500 | 163 ± 0.05 | 72 | 919 |
| 2 | 3 | 400 | 167 ± 1.20 | 67 | 2084 |
| 3 | 3 | 500 | 174 ± 1.80 | 66 | 1587 |
| 4 | 3 | 600 | 173 ± 6.8 | 72 | 1166 |
| 5 | 3 | 900 | 149 ± 5.5 | 81 | 1306 |

When tested in full cell with graphite as an anode there is a significant difference in initial capacity between transition metal fluorides and alkaline earth metal fluorides (e.g. MgF₂, CaF₂) as shown in Table 9. Specifically, transition metal fluorides (e.g. MnF₂ and CoF₂) demonstrate significantly lower (<190 mAh/g) initial discharge capacity compared to alkaline earth metal fluorides and control DR. This also supports that DR reacts with transition metal fluorides upon heating resulting in removal of electrochemically active lithium from the DR structure forming lithium containing inactive coating on DR surface. Whereas alkaline earth metal fluorides may not react with DR in the same fashion as the transition metal fluoride resulting in only negligible initial capacity decrease. It may be desirable for the transition metal fluoride to be used in a lithium metal battery (one having a lithium metal anode including those starting with a metal current collector that subsequently has lithium metal deposited thereon upon formation of the battery). It may be desirable for the alkaline earth fluoride to be employed in a lithium ion battery (e.g., anode other than lithium metal such as one comprised of graphite).

TABLE 9

| | | | | Cycle 1 | Cycle 1 |
|---|---|---|---|---|---|
| | | | Annealing | Discharge | Coulombic |
| | | Amount | Temperature | Capacity | Efficiency |
| Example | Electrolyte | (wt. %) | (° C.) | (mAh/g) | (%) |
| Control | 15 | 0 | No annealing | 265 ± 3.05 | 81 ± 0.15 |
| CoF₂ | 15 | 1 | 500 | 176 ± 3.00 | 74 ± 0.1 |
| CoF₂ | Control | 1 | 500 | 192 ± 1.30 | 76 ± 0.05 |
| MgF₂ | 15 | 1 | 500 | 248 ± 0.80 | 80 ± 0.06 |
| MgF₂ | Control | 1 | 500 | 254 ± 3.65 | 81 ± 0.38 |

Control: Carbonate based electrolyte
15: Non-carbon ate based electrolyte

1. A composition comprising a disordered rock salt having a cation comprised of lithium and at least one other metal and an anion comprised of oxygen having a coating comprised of a metal fluoride, a metal oxyfluoride or combination thereof, wherein the disordered rock salt is represented by chemical formula (i): 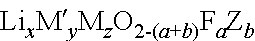
where 1.0<x<1.75; 0.01<y<0.55; 0.1<z<1; 0≤(a+b)<0.7; (b≥0) M′ is one of Ti, Ta, Zr, W, Nb, or Mo; M is one or more of Ti, V, Cr, Mn, Fe, Co, Ni, Cu, Zn, Al, Zr, Y, Mo, Ru, Rh and Sb; and Z is one or more of P, N and S.

2. (canceled)

3. The composition of claim 1, wherein the metal of the coating is comprised of a transition metal.

4. The composition of claim 1, wherein the metal of the coating is comprised of an alkaline earth metal.

5. The composition of claim 1, wherein the coating lacks a spinel.

6. The composition of claim 1, wherein the coating is comprised of a spinel.

7. The composition of claim 1, wherein the metal of the coating is comprised of one or more of Cu, Mn, Ca and Co.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A cathode comprising the composition of claim 1.

21. A battery comprising the cathode of claim 20.
